(19) United States
(12) Patent Application Publication
(10) Pub. No.: US 2014/0014379 A1
(43) Pub. Date: Jan. 16, 2014

(54) IDLER ROLLER ASSEMBLY

(71) Applicant: Raymond Jeffrey Dufty, Ernest (AU)

(72) Inventor: Raymond Jeffrey Dufty, Ernest (AU)

(21) Appl. No.: 13/545,052

(22) Filed: Jul. 10, 2012

(51) Int. Cl. A01B 29/02

(52) U.S. Cl. CPC A01B 29/02
USPC 172/518

(57) ABSTRACT

An idler roller assembly having a roller tube which has a constant diameter throughout its length and does not have machined ends or ends formed with integrally formed flanges. An end cap is attached to each end of the roller tube which has a hollow internal bore and an outer seal insert retained within the hollow internal bore of the end cap and having an internal recess and adapted for rotation with the roller tube and end cap. A stationary inner seal is located in the recess and having a flexible lip. Also included is a bearing retained within the internal bore of the end cap as well as a stationary shaft extending through a hollow interior of the roller tube wherein the inner seal is fixed to the stationary shaft. There is also provided an inner fastening member retaining the bearing in position within the end cap.

### FIELD OF THE INVENTION

This invention relates to an improved idler roller assembly for turf or grass surfaces such as golfing greens or greens used for lawn bowls.

### BACKGROUND OF THE INVENTION

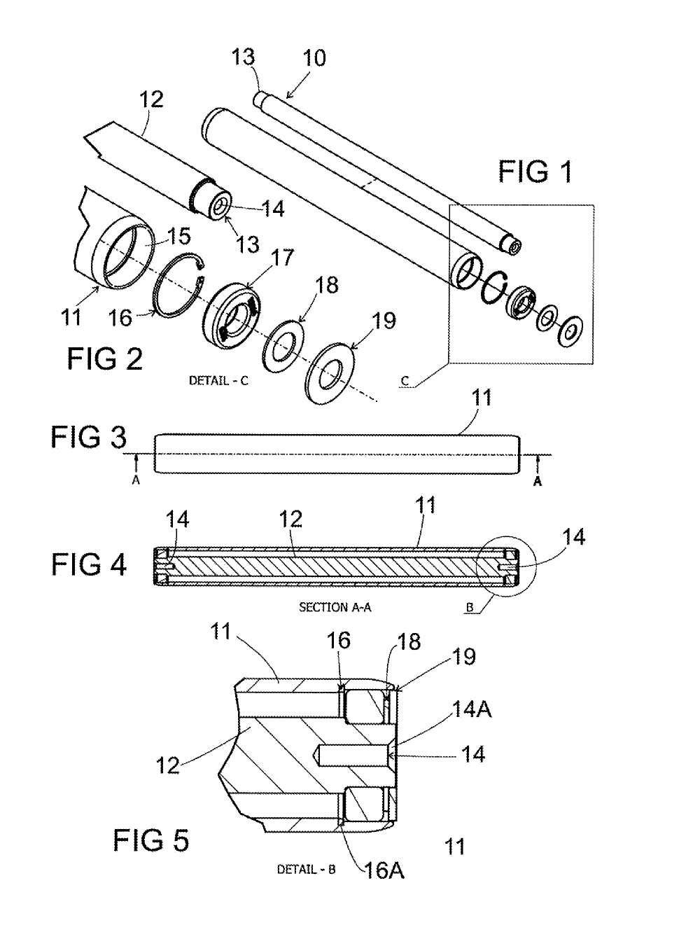

A conventional idler roller assembly used for golfing greens is marketed by Tru-Turf Pty Ltd and as described in FIG. 1 herein. This conventional idler roller assembly includes a roller tube formed from steel which has a machined recess located at each end of the roller tube for retention of a bearing assembly which surrounds an adjacent stub end or reduced diameter end of a shaft which extends through a hollow interior of the roller tube. The bearing assembly included an inner circlip located in a machined recess in the roller tube and an adjacent bearing housing having inner and outer races separated by a plurality of ball bearings and an inner washer and outer washer. This conventional idler roller assembly suffered from a number of disadvantages which included (i) the necessity to machine each end of the roller tube which was expensive in manufacture and which had to be a very precise operation, (ii) the bearing in operation did not operate at its maximum loading or near its maximum loading; and (iii) premature failure due to ingress of impurities such as contaminated water and sand or soil.

Similar problems occurred with an idler roller assembly described in U.S. Pat. No. 518,824 which also had end recesses machined at each end of a roller tube to retain a metal end plate which also supported a bearing located at an inner end of the metal end plate. There was also provided a seal assembly mounted to a stationary shaft which extended through the roller tube which seal assembly included a first seal member mounted to the roller tube and a second seal member mounted to the stationary shaft. The first and second seal members formed a labyrinth like passageway.

In GB 1002666 each outer end of the roller tube had an inturned L shaped flange to retain a bearing and sealing assembly between the flange and a stationary shaft extending through the roller tube. A similar proposal is mentioned in U.S. Pat. No. 8,146,733. It was to be appreciated that providing integrally formed flanges at each end of the roller tube was also an expensive manufacturing option as well as having machined ends as described in the prior art discussed above.

It is also pointed out that both U.S. Pat. No. 4,643,300 and International Publication WO 2011/154904 also had machined ends to retain a metal end cap for supporting a bearing and sealing assembly which surrounded a stationary internal shaft.

### OBJECT OF THE INVENTION

It is therefore an object of the invention to provide an idler roller assembly which reduces the disadvantages of the prior art discussed above and which is efficient in practice.

### SUMMARY OF THE INVENTION

The idler roller assembly of the invention has (i) a roller tube which has a constant diameter throughout its length and which does not have machined ends or ends formed with integrally formed flanges; (ii) an end cap attached to each end of the roller tube having a hollow internal bore; (iii) an outer seal insert retained within the hollow internal bore of the end cap and having an internal recess and adapted for rotation with the roller tube and end cap; (iv) a stationary inner seal located in the recess and having a flexible lip; (v) a bearing retained within the internal bore of the end cap; (vi) a stationary shaft extending through a hollow interior of the roller tube wherein said inner seal is fixed to said stationary shaft; (vii) an inner fastening member retaining the bearing in position within the end cap; and (viii) an outer fastening member retaining the outer seal and inner seal in desired position surrounding the inner shaft.

The end caps may be fitted or attached to an adjacent end of the roller tube in any suitable manner such as being press or interference fitted or using pressure to allow the roller tube to be retained within an adjoining groove of the end cap.

The outer seal insert may be located or fitted into a suitable shoulder or recess of the end cap so that in use it rotates with the end cap and to this end is suitably spaced from the inner seal which is fixed to the inner shaft. The flexible lip of the inner seal may flex in use against the inner shaft to provide a secure sealing function.

In similar manner the bearing may be located or fitted into position within a recess or abutting a shoulder of the end cap and retained in position by the inner fastening member which may be a circlip for example.

The outer fastening member may also be a circlip and there is preferably provided an end plate or shield located between the outer circlip and combination of outer seal insert and inner seal.

### DESCRIPTION OF THE PREFERRED EMBODIMENT OF THE INVENTION

Reference may be made to a preferred embodiment of the invention as shown in the attached drawings wherein:

FIG. 1 refers to a perspective view of a conventional idler roller assembly as described above;

FIG. 2 is a detailed view of section “C” shown in FIG. 1;

FIG. 3 is a side view of the idler roller assembly shown in FIG. 1;

FIG. 4 is a sectional view through line A-A of FIG. 3;

FIG. 5 is a detailed view of section “B” shown in FIG. 4;

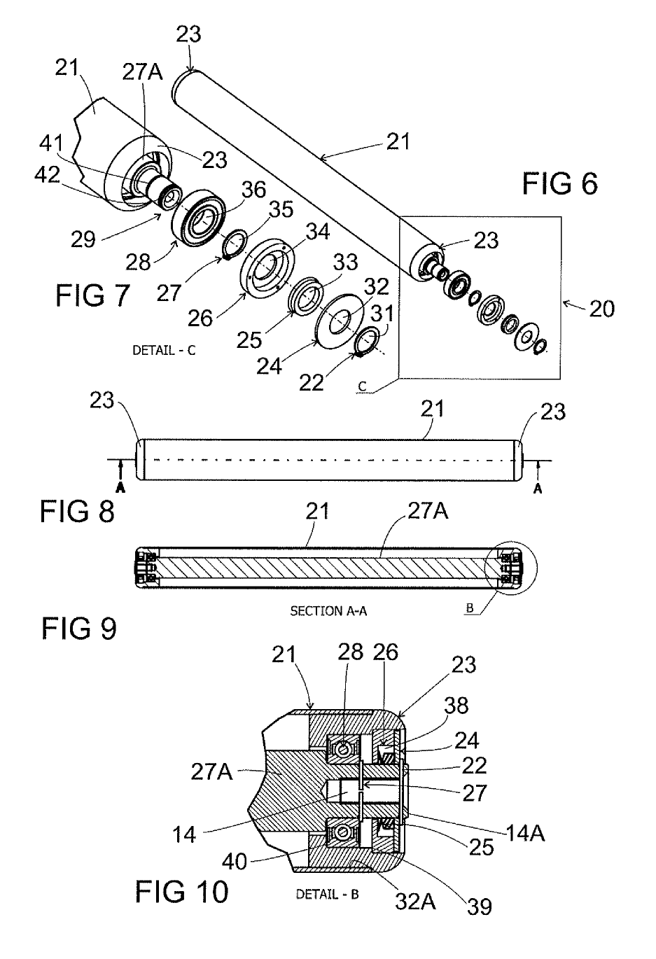

FIG. 6 is a perspective view of an idler roller assembly constructed in accordance with the invention;

FIG. 7 is a detailed view of section “C” shown in FIG. 6;

FIG. 8 is a side view of the idler roller assembly shown in FIG. 6;

FIG. 9 is a sectional view through line A-A of FIG. 8;

FIG. 10 is a detailed view of section “B” shown in FIG. 9;

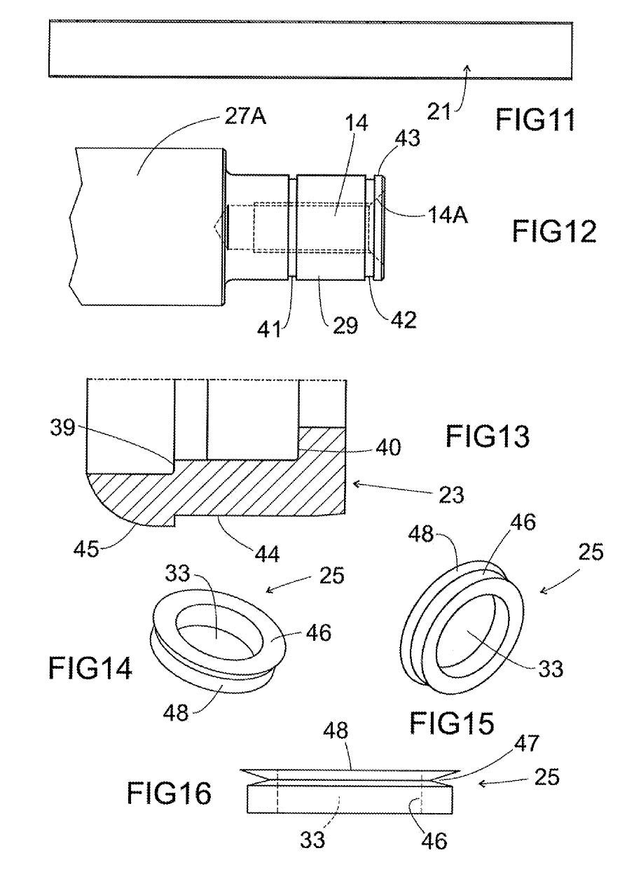

FIG. 11 is a side view of the roller tube used in the idler roller assembly shown in FIG. 6;

FIG. 12 is a detailed view of one end of the internal shaft shown in FIG. 11;

FIG. 13 is a longitudinal half sectional view of the end cap used in the idler roller assembly of FIG. 6;

FIGS. 14-16 are alternative views of the inner seal used in the idler roller assembly of FIG. 6; and

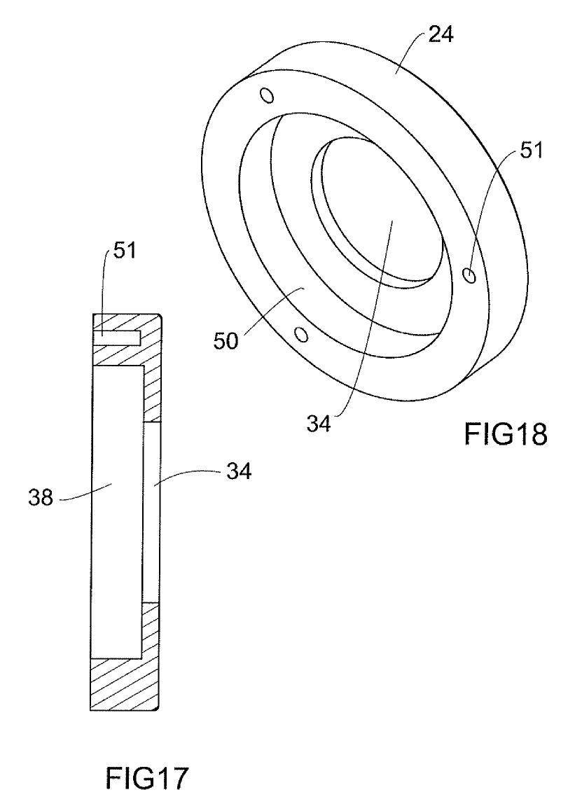

FIGS. 17-18 are a perspective view and a vertical sectional view respectively of the outer seal insert used in the idler roller assembly of FIG. 6.

In FIGS. 1-5 there is shown a conventional idler or smoothing roller assembly 10 which includes a roller tube 11, inner shaft 12 having reduced or stub ends 13 wherein each stub end has a threaded internal passage 14 and head portion 14A. The roller tube 11 has a machined recess 15 which is of slightly larger diameter than the inside diameter of the remainder of roller tube 11. Within recess 15 there is received internal circlip 16 received in machined internal recesses 16A in roller tube 11, bearing 17, inner washer 18 and outer washer 19. It will be appreciated that threaded internal passage 14 is for receiving a fastener in the form of a screw for attaching idler roller assembly to a suitable support (not shown) which is usually a T shaped smoothing head which is pivotally attached to the chassis of a turf rolling assembly as described for example in U.S. Pat. No. 6,457,903.

While the idler roller assembly 10 was satisfactory in most cases it was found that it was expensive in manufacture because of the necessity to machine each recess 15. It will be appreciated that such machinery operation had to be carried out very accurately to provide the minimal tolerance required. It was also found that bearings 17 in the conventional idler roller assembly 10 were not operating at maximum efficiency because insufficient load was placed on bearings 17. The idler roller assembly 10 also suffered from insufficient sealing capacity in some cases allowing for ingress of moisture, grass, dirt and other impurities which adversely affected operation of conventional idler assembly 10.

In FIGS. 6-10 there is shown an idler roller assembly 20 which is constructed in accordance with the invention and which includes roller tube 21 which has no machined internal recesses or integral flanges at each end and thus is of the same diameter throughout. The idler roller assembly 20 also includes external circlip 22, end cap 23, shield 24 for end cap 23, V-ring seal 25, end cap seal insert 26, internal circlip 27, bearing 28, shaft 27A having reduced or stub ends 29 each having a threaded internal passage 14 and head portion 14A. Each of external circlip 22, end cap 23, V-ring seal 25, seal insert 26, bearing 28 and internal circlip 27 have an internal aperture 31, 32, 33, 34, 35 and 36 to allow insertion of a threaded fastener or screw (not shown) to allow attachment of idler roller assembly 20 to a support (not shown) of a smoothing head as described and illustrated in U.S. Pat. No. 6,457,903.

Both external circlip 22 and internal circlip 27 are responsible for retaining each of end cap 23, seal 25, seal insert 26 and bearing 28 in desired position surrounding shaft 27A as shown in FIG. 10 and in particular internal circlip 27 maintains bearing 28 in its correct position on reduced end 29 of shaft 27A and external circlip 22 of shaft 27A maintains end cap 23 in its desired position abutting an internal surface 32A of roller tube 21. External circlip 22 also maintains end cap shield 24 in its desired location. Seal 25 remains stationary within recess 38 of seal insert 26. Seal insert 26 is maintained in desired position by shoulder 39 of end cap 23 and bearing 28 is maintained in desired position abutting shoulder 40 of end cap 23. Each of circlips 22 and 27 are maintained within recesses 41 and 42 of reduced end 29 of axle 27A.

The bearing 28 is a contact bearing and has an outer race which rotates with roller tube 21 and inner race that locks on to shaft 27A. Each of the inner and outer recesses are separated by a plurality of ball bearings and there is provided a seal (not shown) within a suitable groove in each end of bearing 28.

FIGS. 11-16 show more detailed views of roller tube 21, axle 27A and stub end or reduced end 29, end cap 23 and V-ring seal 25.

It will be noted in FIG. 11 that roller tube 21 is of constant diameter throughout its length and does not have any recess or machined ends as in the case of roller tube 11 shown in FIGS. 1-5.

In FIG. 12 is shown internal shaft 27A and reduced end 29 which have internal grooves 41 and 42 in which circlips 22 and 27 are located. There is also provided end flange 43.

In FIG. 13 is shown end cap 23 which has shoulders 39 and 40 and recessed portion 44 which locates roller tube 21 in position as shown in FIG. 10. Roller tube 21 is received within recessed portion 44 preferably by an interference or press fit. There is also provided curved end part 45 to assist in blending any ridging on the ground with the ground when rolling undulations.

FIGS. 14-16 show V-seal 25 which has a V shaped recess 47 as shown in FIG. 16 which allows flexibility of flexible part 48 compared to remaining part 46. Flexible part 48 can flex in relation to seal insert 26 as shown in FIG. 10.

FIGS. 17-18 show seal insert 26 which has one end aperture 33 through which inner shaft 27A may be passed as well as another end aperture 50 and internal recess 38.

There are also provided blind holes or cavities 51 to facilitate separation of seal insert 26 from shaft 27A when required.

In relation to operation of idler roller assembly 20 it will be appreciated that bearing 26, which may have a lower load capacity bearing than bearing 17 shown in FIGS. 1-5, will work much closer to its operational loading capacity because of the combination of end cap 23 and the seal 25 having a flexible component or lip 48 which flexes in relation to stub end 29 of shaft 27A and thus provides a very satisfactory sealing function between shaft 27A and insert 26. This is primarily because seal 25 is fixed in relation to inner shaft 27 and seal insert 26 rotates with roller tube 21.

Also the inclusion of end cap 23 provides a very useful support for both seal 25 and seal insert 26 by the provision of shoulder 39 and bearing 26 is retained in a stable position by shoulder 40. The inclusion of end cap 23 therefore provides a much better functionality to idler roller assembly 20 than the necessity to provide machined recesses 15 in idler roller assembly 10. It will also be appreciated that both the external circlip 22 and internal circlip 27 securely retain both bearing 28 and shield 24 within end cap 23. The primary function of end shield 24 is to protect seal insert 26 and seal 25 from contamination from foreign materials or impurities.

1. An idler roller assembly having (i) a roller tube which has a constant diameter throughout its length and which does not have machined ends or ends formed with integrally formed flanges; (ii) an end cap attached to each end of the roller tube having a hollow internal bore; (iii) an outer seal insert retained within the hollow internal bore of the end cap and having an internal recess and adapted for rotation with the roller tube and end cap; (iv) a stationary inner seal located in the recess and having a flexible lip; (v) a bearing retained within the internal bore of the end cap; (vi) a stationary shaft extending through a hollow interior of the roller tube wherein said inner seal is fixed to said stationary shaft; and (vii) an inner fastening member retaining the bearing in position within the end cap.

2. An idler roller assembly as claimed in claim 1 wherein the end cap has an inner end recessed portion whereby an adjacent end of the roller tube is attached by interference fit or press fit.

3. An idler roller assembly as claimed in claim 1 wherein the outer seal inserted is located into a desired position by an internal shoulder or recess of the end cap.

4. An idler roller assembly as claimed in claim 1 wherein the flexible lip of the inner seal is spaced from a relatively non-flexible part of the inner seal by a V shaped internal cavity.

5. An idler roller assembly as claimed in claim 1 wherein the bearing is located in desired position by an internal recess or shoulder located in the end cap.

6. An idler roller assembly as claimed in claim 1 wherein there is provided an end plate or shield located outwardly of the outer seal insert and stationary inner seal to protect the outer seal insert and stationary inner seal from contamination.

7. An idler roller assembly as claimed in claim 6 wherein there is provided an external circlip retained in desired position by a first locating groove located adjacent an adjoining end of the internal shaft whereby said external circlip retains the end plate or shield in desired position.

8. An idler roller assembly as claimed in claim 7 wherein the inner fastening member is an internal circlip which is retained in desired position by a second locating groove of the internal shaft and positioned inwardly of the first locating groove.
